(19) United States
(12) Patent Application Publication
(10) Pub. No.: US 2013/0062083 A1
(43) Pub. Date: Mar. 14, 2013

(54) AGRICULTURAL IMPLEMENT DRAWBAR MECHANISM

(71) Applicants: Robert T. Casper, Ankeny, IA (US); Shawn J. Becker, Ankeny, IA (US)

(72) Inventors: Robert T. Casper, Ankeny, IA (US); Shawn J. Becker, Ankeny, IA (US)

(21) Appl. No.: 13/232,350

(22) Filed: Sep. 14, 2011

(51) Int. Cl. A01B 63/111

(52) U.S. Cl. 172/452

(57) ABSTRACT

A drawbar mechanism for coupling an earth-working tool to an agricultural implement is disclosed. The agricultural implement includes a frame and a source of hydraulic pressure. The drawbar mechanism includes an extendable and retractable hydraulic cylinder in fluid communication with the source of hydraulic pressure and having a first end pivotally coupled to the frame and a second end. A drawbar having a first portion pivotally coupled to the frame defines a working range. The drawbar having a second portion coupled to the earth-working tool. The second end of the hydraulic cylinder is pivotally coupled to the drawbar enabling a substantially constant down force throughout the working range of the drawbar.

### FIELD OF THE DISCLOSURE

The present disclosure generally relates to agricultural implements for conditioning soil, and more particularly to drawbar mechanisms for supporting an earth-working tool on agricultural implements.

### BACKGROUND OF THE DISCLOSURE

In order to support an earth-working tool on an agricultural implement, agricultural implements commonly include rearwardly-projecting arms. The arms are pivotally mounted to a frame of the agricultural implement and are biased downward by spring structure so that the earth-working tool is engaged with the soil. The spring structure creates a down force on the earth-working tool. Each spring structure must be adjusted separately to change the down force. The down force changes over time due to spring fatigue.

The arms are often attached to a hydraulic cylinder to raise the earth-working tool away from the soil for transport purposes. The hydraulic cylinder works against the bias of the spring structure.

A cylinder lost motion connection is often used to facilitate movement of the earth-working tool over soil irregularities and obstacles. The cylinder lost motion connection is illustrated in commonly assigned U.S. Pat. No. 7,766,093.

### SUMMARY OF THE DISCLOSURE

In one embodiment, a drawbar mechanism for coupling an earth-working tool to an agricultural implement is disclosed. The agricultural implement includes a frame and a source of hydraulic pressure. The drawbar mechanism includes an extendable and retractable hydraulic cylinder in fluid communication with the source of hydraulic pressure and having a first end pivotally coupled to the frame and a second end. A drawbar having a first portion pivotally coupled to the frame defines a working range. The drawbar having a second portion coupled to the earth-working tool. The second end of the hydraulic cylinder is pivotally coupled to the drawbar enabling a substantially constant down force throughout the working range of the drawbar.

In another embodiment, a drawbar mechanism for coupling an earth-working tool to an agricultural implement is disclosed. The agricultural implement includes a frame and a source of hydraulic pressure. The drawbar mechanism includes a bracket coupled to the frame. The drawbar mechanism includes an extendable and retractable hydraulic cylinder in fluid communication with the source of hydraulic pressure and having a first end pivotally coupled to the frame and a second end. A drawbar having a first portion pivotally coupled to the frame defines a working range. The drawbar having a second portion coupled to the earth-working tool. The second end of the hydraulic cylinder is pivotally coupled to the drawbar enabling a substantially constant down force throughout the working range of the drawbar.

In yet another embodiment, an agricultural implement includes a source of hydraulic pressure and a coupling mechanism for coupling to a vehicle. A frame having a tool tube is coupled to the coupling mechanism and extends from the coupling mechanism. The frame is adapted to be pulled by the vehicle in a direction of travel. A plurality of wheel assemblies is coupled to the frame. The wheel assemblies support the frame above a surface. A drawbar mechanism having a bracket is coupled to the tool tube. The drawbar mechanism has an extendable and retractable hydraulic cylinder in fluid communication with the source of hydraulic pressure and with a first end pivotally coupled to the bracket and a second end. The drawbar mechanism has a drawbar with a first portion pivotally coupled to the bracket and defining a working range. The drawbar has a second portion coupled to the earth-working tool. The second end of the hydraulic cylinder is pivotally coupled to the drawbar enabling a substantially constant down force throughout the working range of the drawbar.

### BRIEF DESCRIPTION OF THE DRAWINGS

FIG. 1 is a perspective view of an agricultural implement according to one embodiment.

FIG. 2 is a side view of a rear portion of the agricultural implement of FIG. 1, showing the drawbar mechanism in a first position.

FIG. 3 is a side view of a rear portion of the agricultural implement of FIG. 1, showing the drawbar mechanism in a second position.

FIG. 4 is a top perspective view of a drawbar mechanism of the agricultural implement of FIG. 1.

FIG. 5 is a bottom perspective view of a drawbar mechanism of the agricultural implement of FIG. 1.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

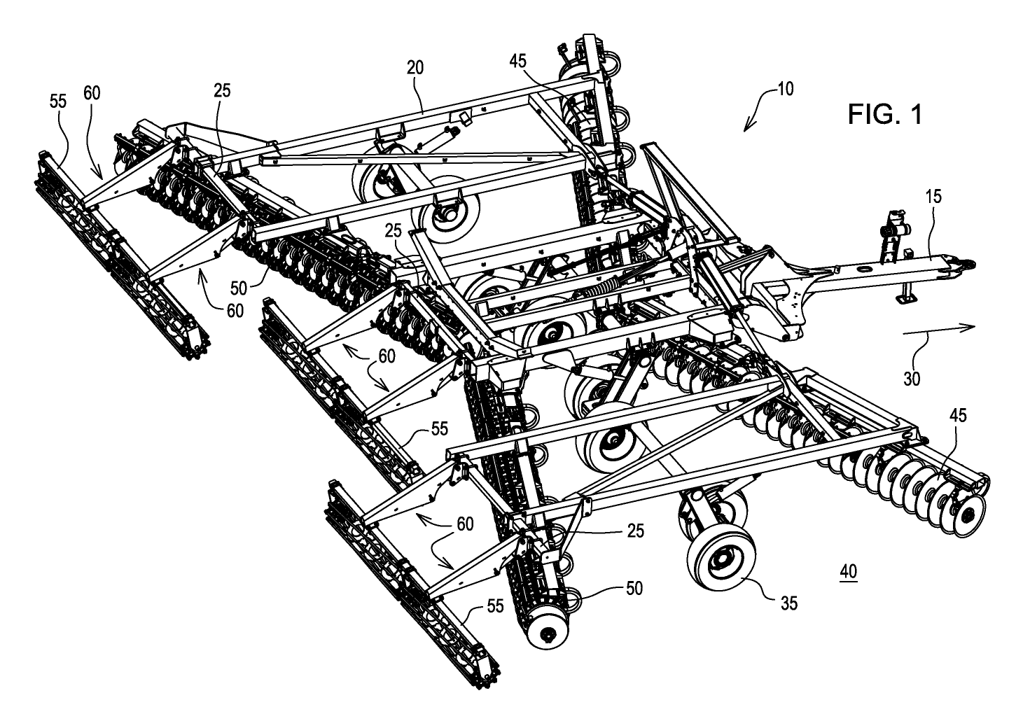

FIG. 1 illustrates an agricultural implement 10. The illustrated agricultural implement 10 includes a coupling mechanism 15 for coupling to a vehicle (not shown).

A frame 20 having a plurality of tool tubes 25 is coupled to the coupling mechanism 15. The frame 20 extends rearwardly from the coupling mechanism 15 in a direction opposite of a direction of travel 30. A plurality of wheel assemblies 35 are coupled to the frame 20. The wheel assemblies 35 support the frame 20 above a surface 40.

A source of hydraulic pressure (not shown) is coupled to the frame 20. A disk gang assembly 45 and a coulter disk gang assembly 50 are coupled to the frame 20. A plurality of earth-working tools (e.g., rolling basket, harrow) 55 is coupled to a plurality of drawbar mechanisms 60, which is coupled to the frame 20.

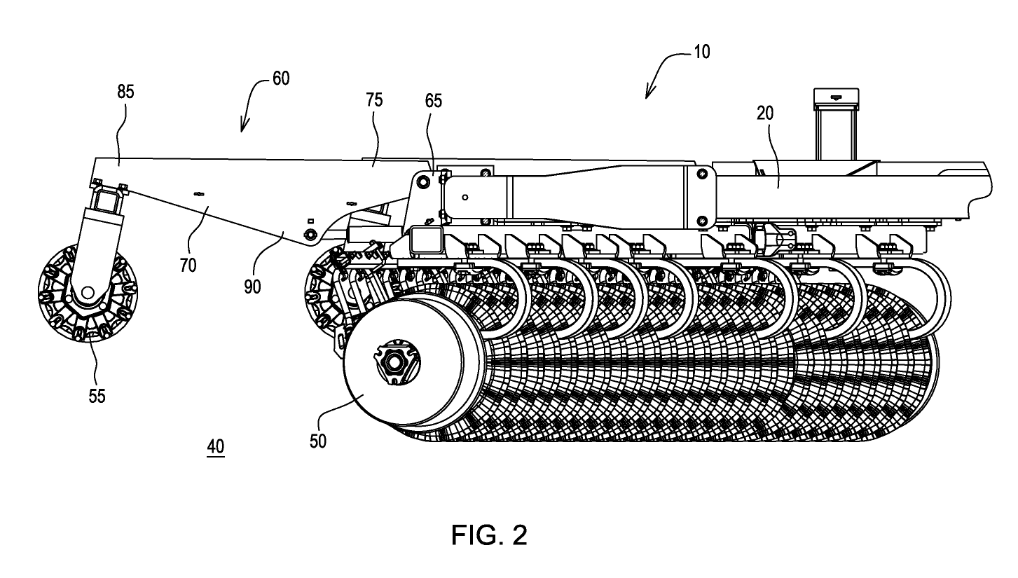

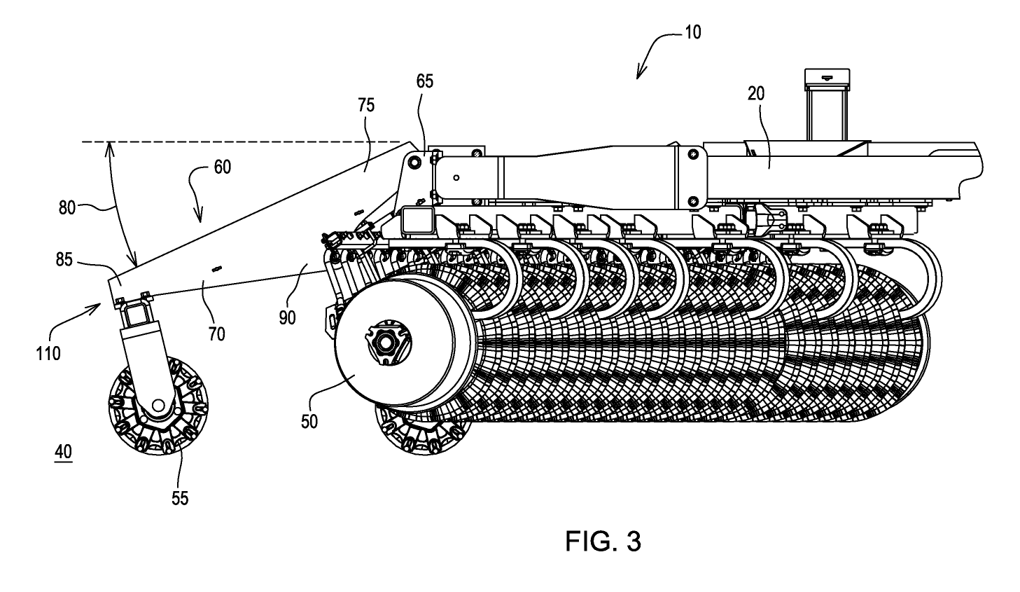

With reference to FIGS. 2 and 3, each drawbar mechanism 60 includes a bracket 65. The bracket 65 is coupled to the tool tube 25 of the frame 20. The drawbar mechanism 60 includes a drawbar 70 having a first portion 75 pivotally coupled to the bracket 65 and defining a working range 80 (FIG. 3). The drawbar 70 has a second portion 85 coupled to the earth-working tool 55. The drawbar 70 includes a middle portion 90 positioned between the first portion 75 and the second portion 85.

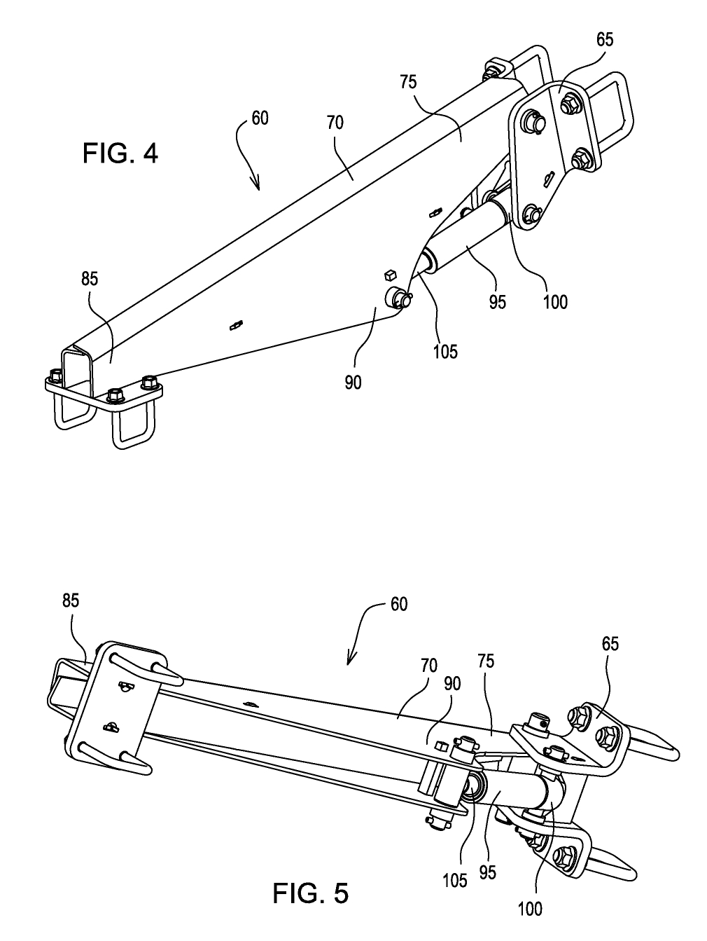

Referring to FIGS. 4 and 5, an extendable and retractable hydraulic cylinder 95 having a first end 100 is pivotally coupled to the bracket 65. The hydraulic cylinder 95 has a second end 105 pivotally coupled to the drawbar 70. The second end 105 may be pivotally coupled to the middle portion 90 of the drawbar 70. The hydraulic cylinder 95 is double acting. Alternatively, a spring-protected linear actuator (not shown) could be used to eliminate the need for the hydraulic cylinder 95.

With reference to FIG. 3, the working range 80 includes a first position 110 (FIG. 3) where the earth-working tool 55 is engaged with the surface 40 and the hydraulic cylinder 95 is operable to absorb an impact caused by the surface 40. Alternatively, a lost motion connection (not shown) may be used to absorb impacts. Or, in the case of the spring-protected linear actuator, the spring may be used to absorb impacts. The working range 80 includes a second position 115 (FIG. 2) where the earth-working tool 55 is not engaged with the surface 40 and is in position for transport.

In operation, the coupling mechanism 15 is coupled to the vehicle and pulled in the direction of travel 30. The source of hydraulic pressure can be adjusted at one location, which adjusts the hydraulic pressure received at each hydraulic cylinder 95. The hydraulic pressure received at each hydraulic cylinder 95 determines the down force at each earth-working tool 55. The drawbar mechanisms 60 are placed in the first position 110 where the earth-working tools 55 are engaged with the surface 40. During operation, the earth-working tools 55 follow the contour of the surface 40 and are operable to move throughout the working range 80 while providing a constant down force. When ready for transport or when field conditions require (e.g., wet conditions), the drawbar mechanisms 60 are placed in the second position 115 where the earth-working tools 55 are not engaged with the surface 40.

Advantageously, the drawbar mechanism 60 is self-adjusting, which enables the earth-working tool 55 to follow the contour of the surface 40 while providing a constant down force. The drawbar mechanism 60 is configured such that the ratio of the moment applied to the drawbar 70 and the resistive moment of the surface 40 is near constant throughout the working range 80. Maintaining a constant ratio of moments enables a constant input pressure to the hydraulic cylinder 95 to yield a constant down force into the surface 40. This configuration allows the surface 40 contour under the agricultural implement 10 to change without requiring an adjustment to the drawbar mechanism 60 and the earth-working tool 55.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

Various features are set forth in the following claims.

What is claimed is:

1. A drawbar mechanism for coupling an earth-working tool to an agricultural implement, the agricultural implement including a frame and a source of hydraulic pressure, the drawbar mechanism comprising:
an extendable and retractable hydraulic cylinder in fluid communication with the source of hydraulic pressure and comprising a first end pivotally coupled to the frame and a second end; and
a drawbar comprising a first portion pivotally coupled to the frame and defining a working range, and a second portion coupled to the earth-working tool;
wherein the second end of the hydraulic cylinder is pivotally coupled to the drawbar enabling a substantially constant down force throughout the working range of the drawbar.

2. The drawbar mechanism of claim 1, further comprising a bracket coupled to the frame, pivotally coupled to the first end of the hydraulic cylinder, and pivotally coupled to the first portion of the drawbar.

3. The drawbar mechanism of claim 1, wherein the hydraulic cylinder is a double-acting hydraulic cylinder.

4. The drawbar mechanism of claim 1, wherein the drawbar comprises a middle portion positioned between the first portion and the second portion, the second end of the hydraulic cylinder is pivotally coupled to the middle portion.

5. The drawbar mechanism of claim 1, wherein the working range comprises a first position where the earth-working tool is engaged with a surface and the hydraulic cylinder is operable to absorb an impact caused by the surface and a second position where the earth-working tool is not engaged with the surface.

6. The drawbar mechanism of claim 1, wherein the earth-working tool is a rolling basket.

7. The drawbar mechanism of claim 1, wherein the earth-working tool is a harrow.

8. A drawbar mechanism for coupling an earth-working tool to an agricultural implement, the agricultural implement including a frame and a source of hydraulic pressure, the drawbar mechanism comprising:
a bracket coupled to the frame;
an extendable and retractable hydraulic cylinder in fluid communication with the source of hydraulic pressure and comprising a first end pivotally coupled to the bracket and a second end; and
a drawbar comprising a first portion pivotally coupled to the bracket and defining a working range, and a second portion coupled to the earth-working tool;
wherein the second end of the hydraulic cylinder is pivotally coupled to the drawbar enabling a substantially constant down force throughout the working range of the drawbar.

9. The drawbar mechanism of claim 8, wherein the hydraulic cylinder is a double-acting hydraulic cylinder.

10. The drawbar mechanism of claim 8, wherein the drawbar comprises a middle portion positioned between the first portion and the second portion, the second end of the hydraulic cylinder is pivotally coupled to the middle portion.

11. The drawbar mechanism of claim 8, wherein the working range comprises a first position where the earth-working tool is engaged with a surface and the hydraulic cylinder is operable to absorb an impact caused by the surface and a second position where the earth-working tool is not engaged with the surface.

12. The drawbar mechanism of claim 8, wherein the earth-working tool is a rolling basket.

13. The drawbar mechanism of claim 8, wherein the earth-working tool is a harrow.

14. An agricultural implement comprising:
a coupling mechanism for coupling to a vehicle;
a frame comprising a tool tube, the frame coupled to the coupling mechanism and extending from the coupling mechanism and adapted to be pulled by the vehicle in a direction of travel;
a plurality of wheel assemblies coupled to the frame, the wheel assemblies supporting the frame above a surface;
a source of hydraulic pressure coupled to the frame;
an earth-working tool; and
a drawbar mechanism comprising:
a bracket coupled to the tool tube;
an extendable and retractable hydraulic cylinder in fluid communication with the source of hydraulic pressure and comprising a first end pivotally coupled to the bracket and a second end; and
a drawbar comprising a first portion pivotally coupled to the bracket and defining a working range, and a second portion coupled to the earth-working tool;
wherein the second end of the hydraulic cylinder is pivotally coupled to the drawbar enabling a substantially constant down force throughout the working range of the drawbar.

15. The agricultural implement of claim 14, wherein the hydraulic cylinder is a double-acting hydraulic cylinder.

16. The agricultural implement of claim 14, wherein the drawbar comprises a middle portion positioned between the first portion and the second portion, the second end of the hydraulic cylinder is pivotally coupled to the middle portion.

17. The agricultural implement of claim 14, wherein the working range comprises a first position where the earth-working tool is engaged with the surface and the hydraulic cylinder is operable to absorb an impact caused by the surface and a second position where the earth-working tool is not engaged with the surface.

18. The agricultural implement of claim 14, wherein the earth-working tool is a rolling basket.

19. The agricultural implement of claim 14, wherein the earth-working tool is a harrow.

20. The agricultural implement of claim 14, further comprising a disk gang assembly coupled to the frame.
